(19) United States
(12) Patent Application Publication
(10) Pub. No.: US 2018/0034731 A1
(43) Pub. Date: Feb. 1, 2018

(54) DEVICE AND METHOD FOR HANDLING EFFECTIVE PATH OF CHANNEL IMPULSE RESPONSE

(71) Applicant: MStar Semiconductor, Inc., Hsinchu Hsien (TW)

(72) Inventors: Fang-Ming Yang, Hsinchu Hsien (TW); Tai-Lai Tung, Hsinchu Hsien (TW)

(21) Appl. No.: 15/424,076

(22) Filed: Feb. 3, 2017

(30) Foreign Application Priority Data
Aug. 1, 2016 (TW) 105124262

(51) Int. Cl. H04L 12/721; H04L 25/02; H04L 12/26; H04L 5/00

(52) U.S. Cl. CPC H04L 45/70; H04L 5/005; H04L 25/0212; H04L 5/006; H04L 43/16; H04L 27/2601

(57) ABSTRACT

A communication device includes: a receiving circuit, receiving a plurality of pilot signals; a channel estimating circuit, coupled to the receiving circuit, estimating a channel frequency response according to the pilot signals; a transforming circuit, coupled to the channel estimating circuit, transforming the channel frequency response to a channel impulse response according to a time-frequency transform operation; a calculating circuit, coupled to the transforming circuit, determining a threshold according to a maximum path intensity of a plurality of paths of the channel impulse response, a signal-to-noise ratio (SNR) and a predetermined constant; and a selecting circuit, coupled to the calculating circuit, determining at least one effective path from the paths of the channel impulse response according to the threshold.

This application claims the benefit of Taiwan application Serial No. 105124262, filed Aug. 1, 2016, the subject matter of which is incorporated herein by reference.

### BACKGROUND OF THE INVENTION

### Field of the Invention

The invention relates in general to a device and method for a communication system, and more particularly to a device and method for handling an effective path of a channel impulse response.

### Description of the Related Art

In the operation of a communication system, a transmitter usually uses a part of resources to transmit known reference signals, so that a receiver may use these reference signals to estimate a channel (i.e., a channel used for transmitting data) and use the estimated channel to restore the data originally transmitted. For example, a channel usually includes multiple paths, which need to be correctly identified by the receiver to increase the accuracy of channel estimation. However, a channel features properties of being random and time-variant (especially in a wireless communication system), and a receiver also suffers from noise interference when performing channel estimation. As a result, it may be difficult for a receiver to correctly identify these paths from the result of channel estimation. Further, the probability of correctly restoring data may be lowered as a receiver restores the data originally transmitted according to incorrect channel information. Therefore, there is a need for a solution that correctly identifies paths of a channel.

### SUMMARY OF THE INVENTION

The invention is directed to a device and method for handling an effective path of channel impulse response. The device and method are capable of accurately identifying paths of a channel to solve the above issues.

The present invention discloses a communication device. The communication device includes: a receiving circuit, receiving a plurality of pilot signals; a channel estimating circuit, coupled to the receiving circuit, estimating a channel frequency response; a transforming circuit, coupled to the channel estimating circuit, transforming the channel frequency response to a channel impulse response according to a time-frequency transform operation; a calculating circuit, coupled to the transforming circuit, determining a threshold according to a maximum path intensity of a plurality of paths of the channel impulse response, a signal-to-noise ratio (SNR) and a predetermined constant; and a selecting circuit, coupled to the calculating circuit, determining at least one effective path from the paths of the channel impulse response.

The present invention further discloses a method for handling an effective path. The method includes: estimating a channel frequency response; transforming the channel frequency response to a channel impulse response according to a time-frequency transform operation; determining a threshold according to a maximum path intensity of a plurality of paths of the channel impulse response, a signal-to-noise ratio (SNR) and a predetermined constant; and determining at least one effective path from the paths of the channel impulse response.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a communication system according to an embodiment of the present invention;

FIG. 2 is a block diagram of a communication system according to an embodiment of the present invention;

FIG. 3 is a schematic diagram of channel paths of a channel impulse response according to an embodiment of the present invention; and

FIG. 4 is a flowchart of a process according to an embodiment of the present invention.

### DETAILED DESCRIPTION OF THE INVENTION

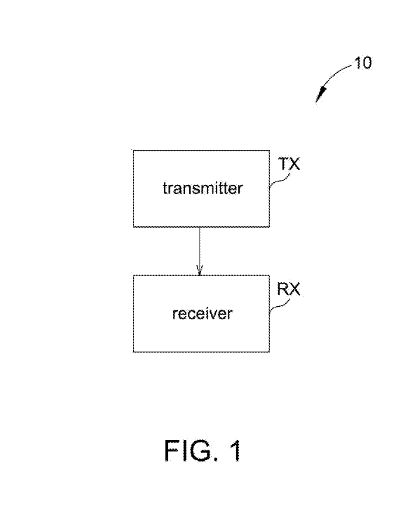

FIG. 1 shows a block diagram of a communication system 10 according to an embodiment of the present invention. The communication system 10 may be any communication system that transmits and/or receives single-carrier or multi-carrier signals, and is and is primarily formed by a transmitter TX and a receiver RX. For example but not limited to, the multi-carrier signal may be an orthogonal frequency-division multiplexing (OFDM) signal (or referred to as a discrete multi-tone modulation (DMT) signal). In FIG. 1, the transmitter TX and the receiver RX are for illustrating the architecture of the communication system 10. For example, the communication system 10 may be wired communication system such as an asymmetric digital subscriber line (ADSL) system, a power line communication (PLC) system or an Ethernet over coax (EOC) system, or a wireless communication system such as a wireless local area network (WLAN), a Digital Video Broadcasting (DVB) system or a Long Term Evolution-Advanced (LTE-A) system. The DVB system may include a Digital Terrestrial Multimedia Broadcast (DTMB) system, a DVB-Terrestrial (DVT-T) system, a DVB Second Generation Terrestrial/Cable (DVB-T2/C2) system and an Integrated Services Digital Broadcasting (ISDB) system. Further, for example but not limited to, the transmitter TX and the receiver RX may be disposed in a mobile phone, a laptop computer, a tablet computer, an e-book or a portable computer system.

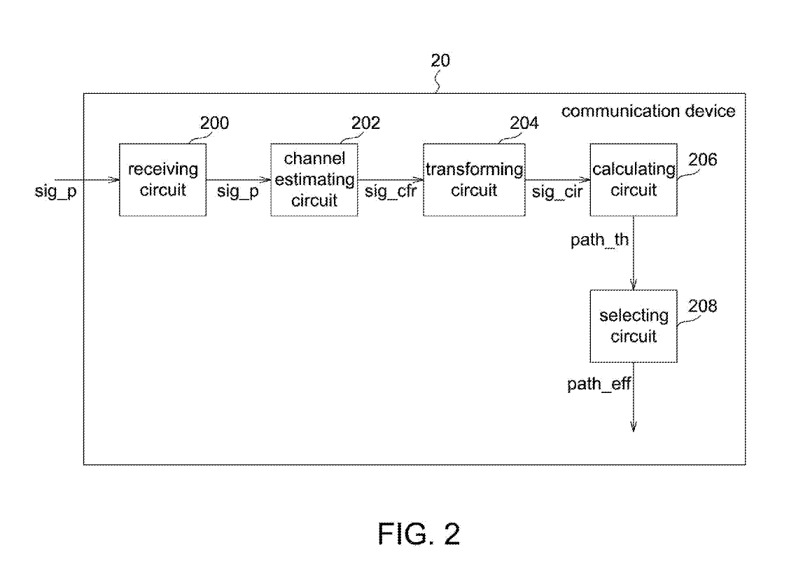

FIG. 2 shows a schematic diagram of a communication device 20 according to an embodiment of the present invention. The communication device 20 is applicable in the receiver RX in FIG. 1, and is used for handling channel paths of a channel impulse response. The communication device 20 includes a receiving circuit 200, a channel estimating circuit 202, a transforming circuit 204, a calculating circuit 206 and a selecting circuit 208. More specifically, after receiving a plurality of pilot signals sig_p, the receiving circuit 200 provides the pilot signals sig_p to the channel estimating circuit 202. The pilot signals sig_p may be any reference signals known to the communication device 20 for the communication device 20 to perform channel estimation. The channel estimating circuit 202, coupled to the receiving circuit 200, estimates a channel frequency response sig_cfr according to the pilot signals sig_p. The transforming circuit 204, coupled to the channel estimating circuit 202, transforms the channel frequency response sig_cfr to a channel impulse response sig_cir according to a time-frequency transform operation. For example but not limited to, the time-frequency transform operation may be an algorithm such as inverse fast Fourier transform (IFFT) that transforms a frequency-domain signal to a time-domain signal.

The calculating circuit 206, coupled to the transforming circuit 204, determines a threshold path_th according to a maximum path intensity of a plurality of paths of the channel impulse response sig_cir, a signal-to-noise ratio (SNR) and a predetermined constant. The predetermined constant may be determined, for example but not limited to, according to the SNR, design considerations and/or system requirements. The selecting circuit 208, coupled to the calculating circuit 206, determines at least one effective path path_eff from a plurality of paths of the channel impulse response sig_cir.

Based on the above discussion, the threshold path_th for determining the effective path is determined according to the maximum path intensity, the SNR and the predetermined constant. In a situation where the SNR usually dynamically changes, the threshold path_th also correspondingly dynamically changes, i.e., a value of the threshold path_th is also a dynamic value. Thus, the threshold path_th is not restrained by one single fixed factor, and is capable of improving the flexibility and accuracy of determining an effective path to further enhance the accuracy of channel estimation.

In one embodiment, the calculating circuit 206 may obtain the SNR according to a plurality of received signals that include a plurality of pilot signals sig_p. That is to say, the calculating circuit 206 may obtain (or update) the SNR while receiving received signals including pilot signals, such that the SNR may more realistically reflect current channel conditions. Further, the plurality of received signals may be a plurality of frequency-domain signals. In one embodiment, the plurality of received signals may be a plurality of orthogonal frequency-division multiplexing (OFDM) signals. In the above situation, the plurality of pilot signals sig_p may be transmitted to the receiver RX on a part of or all subcarriers.

In one embodiment, a path intensity of the at least one effective path is greater than the threshold path_th. In another one embodiment, the path intensities of other paths of the plurality of paths are not greater than the threshold path_th. That is to say, the threshold path_th may be used to determine whether a path is effective. When the path intensity of the path is greater than the threshold path_th, the selecting circuit 208 determines that the path is effective; when the path intensity of the path is not greater than the threshold path_th, the selecting circuit 28 determines that the path is ineffective. The communication device 20 may regard the ineffective path as noise instead of a part of the channel. In one embodiment, a sum of the threshold path_th, the predetermined constant and the SNR is the maximum path intensity. More specifically, when values of the threshold path_th, the predetermined constant, the SNR and the maximum path intensity are T, C, S_{SNR} and S_{MAX}, respectively, the calculating circuit 206 may obtain the value of the threshold path_th according to an equation “T=Sₘₐₓ−S_{SNT}−C”. It should be noted that, the path intensity may be, for example but not limited to, in a value such as power (in a unit of dB), whose value can be compared. In the above equation, parameters may be defined as: S_{MAX} is the power of a largest signal path estimated, S_{SNR} is an average estimated SNR in the system band, and C is the ratio of a smallest signal to noise that is set in the system. Assuming C is set as 10 dB and the estimated S_{SNR} is 20 dB, it may be deduced that, when a power of a signal path in the channel impulse response is smaller than the largest signal path by 30 (20+10)db, the signal path may be considered noise, and the effective path is determined accordingly. Further, the values of the parameters may be set differently based on the environment, and are not limited to the above examples.

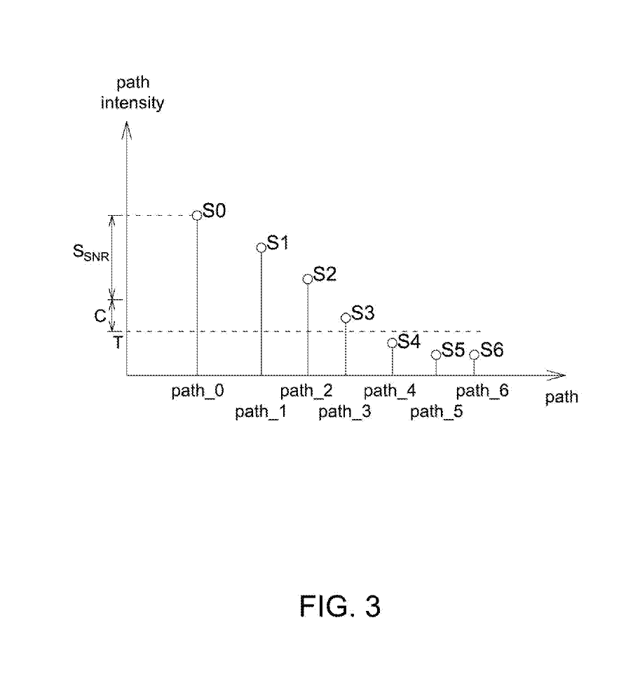

FIG. 3 shows a schematic diagram of a channel path of a channel impulse response according to an embodiment of the present invention as an example for illustrating operations of the communication device 20. FIG. 3 depicts 7 paths path_0 to path_6 of a channel impulse response (e.g., the channel impulse response sig_cir) that have path intensities S₀ to S₆, respectively. The paths path_0 to path_6 may be regarded as initial results of channel estimation, and include effective and ineffective paths. That is to say, FIG. 3 may be obtained through the operations of the receiving circuit 200, the channel estimating circuit 202 and the transforming circuit 204. As shown, the path path_0 has the maximum path intensity. According to the foregoing discussion, assuming that the values of the threshold path_th, the predetermined constant and the SNR are respectively T, C and S_{SNR}, the calculating circuit 206 may obtain the value of the threshold path_th according to the equation “T=Sₘₐₓ−S_{SNR}−C”. Thus, according to the value of the threshold path_th, the selecting circuit 208 may determine that the path intensities S₀ to S₃ of the paths path_0 to path_3 are greater than the threshold path_th, and that the path intensities S₄ to S₆ of the paths path_4 to path_6 are smaller than the threshold path_th. The selecting circuit 208 then determines that the effective paths are the paths path_0 to path 3, and the ineffective paths are the path_4 to path_6.

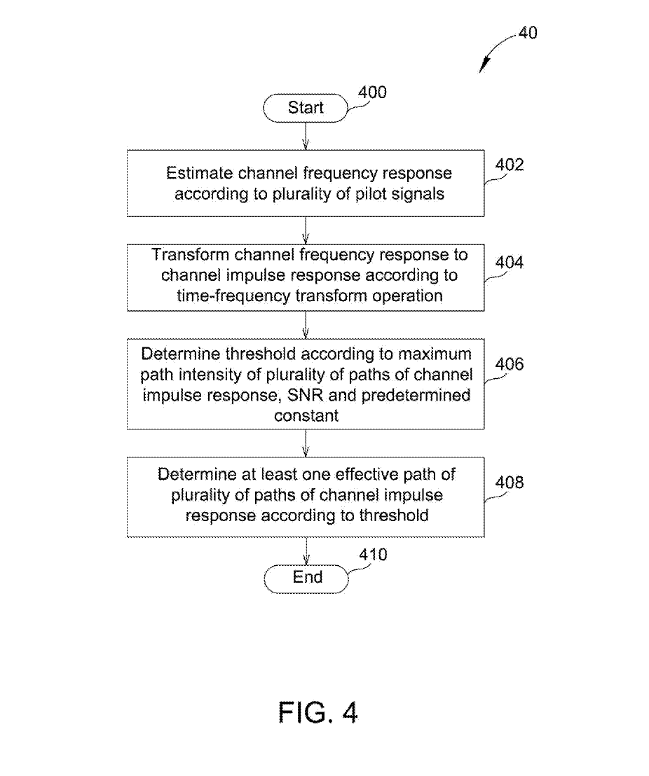

The operations of the communication device 20 may be concluded into a process 40 applied to the communication device 20, as shown in FIG. 4. The process 40 includes following steps.

In step 400, the process 40 begins.

In step 402, a channel frequency response is estimated according to a plurality of pilot signals.

In step 404, the channel frequency response is transformed to a channel impulse response according to a time-frequency transform operation.

In step 406, a threshold is determined according to a maximum path intensity of a plurality of paths of the channel impulse response, an SNR and a predetermined constant.

In step 408, at least one effective path is determined from the plurality of paths of the channel impulse response according to the threshold.

In step 410, the process 40 ends.

The process 40 is an example for illustrating operations of the communication device 20, and associated details and variations may be referred from the description in the above paragraphs.

It should be noted that, there are numerous ways for realizing the communication device 20 (as well as the receiving circuit 200, the channel estimating circuit 202, the transforming circuit 204, the calculating circuit 206 and the selecting circuit 208 included therein). For example, based on design considerations or system requirements, the receiving circuit 200, the channel estimating circuit 202, the transforming circuit 204, the calculating circuit 206 and the selecting circuit 208 may be integrated into one or multiple circuits, which are usually digital circuits in practice. In some embodiments, the receiving circuit 200 may further include an analog-to-digital converter (ADC). Further, the communication device 20 may be realized by at least one of hardware, software, firmware (a combination of a hardware device with computer instructions and data, with the computer instructions and data being read-only software on the hardware device), and an electronic system.

In conclusion, the present invention provides a device and method for handling an effective path of a channel impulse response. In the device and method, the threshold is dynamically determined according to the maximum path intensity, the SNR and the predetermined constant. As the SNR usually dynamically changes, the threshold also correspondingly dynamically changes, i.e., the threshold is a dynamic value, and is not restrained by one single fixed factor. Therefore, the device and method of the present invention improve the flexibility and accuracy for determining the effective path to further enhance the accuracy of channel estimation.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication device, comprising:
a receiving circuit, receiving a plurality of pilot signals;
a channel estimating circuit, coupled to the receiving circuit, estimating a channel frequency response according to the plurality of pilot signals;
a transforming circuit, coupled to the channel estimating circuit, transforming the channel frequency response to a channel impulse response according to a time-frequency transform operation;
a calculating circuit, couple to the transforming circuit, determining a threshold according to a maximum path intensity of a plurality of paths of the frequency impulse response, a signal-to-noise ratio (SNR) and a predetermined constant; and
a selecting circuit, coupled to the calculating circuit, determining at least one effective path from the plurality of paths of the channel impulse response according to the threshold.

2. The communication device according to claim 1, wherein the calculating circuit obtains the SNR according to a plurality of received signals comprising the plurality of the pilot signals.

3. The communication device according to claim 2, wherein the plurality of received signals are a plurality of frequency-domain signals.

4. The communication device according to claim 2, wherein the plurality of received signals are a plurality of orthogonal frequency-division multiplexing (OFDM) signals.

5. The communication device according to claim 1, wherein at least one path intensity of the at least one effective path is greater than the threshold.

6. The communication device according to claim 1, wherein path intensities of the other paths of the plurality of paths are not greater than the threshold.

7. The communication device according to claim 1, wherein a sum of the threshold, the predetermined constant and the SNR is the maximum path intensity.

8. The communication device according to claim 1, wherein the time-frequency transform operation comprises an inverse fast Fourier transform (IFFT).

9. A method for handling an effective path, comprising:
receiving a plurality of pilot signals by a receiving circuit;
estimating a channel frequency response according to the plurality of pilot signals by a channel estimating circuit;
transforming the channel frequency response to a channel impulse response according to a time-frequency transform operation by a transforming circuit;
determining a threshold according to a maximum path intensity of a plurality of paths of the frequency impulse response, a signal-to-noise ratio (SNR) and a predetermined constant by a calculating circuit; and
determining at least one effective path from the plurality of paths of the channel impulse response according to the threshold by a selecting circuit.

10. The method according to claim 9, further comprising:
obtaining the SNR according to a plurality of received signals comprising the plurality of the pilot signals by the calculating circuit.

11. The method according to claim 10, wherein the plurality of received signals are a plurality of frequency-domain signals.

12. The method according to claim 10, wherein the plurality of received signals are a plurality of orthogonal frequency-division multiplexing (OFDM) signals.

13. The method according to claim 9, wherein at least one path intensity of the at least one effective path is greater than the threshold.

14. The method according to claim 9, wherein path intensities of the other paths of the plurality of paths are not greater than the threshold.

15. The method according to claim 9, wherein a sum of the threshold, the predetermined constant and the SNR is the maximum path intensity.

16. The method according to claim 9, wherein the time-frequency transform operation comprises an inverse fast Fourier transform (IFFT).
